(19) United States
(12) Patent Application Publication
(10) Pub. No.: US 2026/0094228 A1
(43) Pub. Date: Apr. 2, 2026

(54) NEURAL NETWORK BASED GRAPHICS RENDERING

(71) Applicant: ADVANCED MICRO DEVICES, INC., Santa Clara, CA (US)

(72) Inventor: Kunal Tyagi, Tokyo (JP)

(21) Appl. No.: 18/901,288

(22) Filed: Sep. 30, 2024

(51) Int. Cl. G06T 1/20; G06T 3/40; G06T 5/70; G06T 9/00

(52) U.S. Cl. CPC G06T 1/20; G06T 3/40; G06T 5/70; G06T 9/00; G06T 2207/20081; G06T 2207/20084

(57) ABSTRACT

Methods and systems for optimizing cloud gaming performance using a neural network-based rendering pipeline are provided. The rendering pipeline includes multiple processing stages that generate intermediate data based on received scene data. At least one processing stage utilizes a trained neural network to perform transformations such as denoising, encoding, decoding, and upscaling on the intermediate data. In certain embodiments, local and/or predicted user input is provided as input to the trained neural networks to adjust the rendering process. The frame is rendered for display based on the intermediate data generated by the neural network.

### BACKGROUND

The proliferation of cloud gaming services has transformed interactive entertainment by enabling access to high-quality games on a wide range of devices without the need for powerful local hardware. This approach leverages remote servers to perform the computationally intensive tasks of game rendering and processing, streaming the results to users' devices in real-time. Users can thereby enjoy graphically demanding games on relatively low-specification devices such as smartphones, tablets, and lightweight laptops.

However, such cloud gaming approaches include inherent tradeoffs between visual fidelity, latency, and frame rate. High-quality graphics require substantial data to be transmitted from the server to the client device, which can lead to increased latency and reduced frame rates. Conversely, reducing the graphical quality to lower the data transmission burden often results in a diminished gaming experience that lacks the visual appeal and smoothness users expect.

Moreover, limitations of network bandwidth and the variability of internet connection quality introduces data transmission latency over long distances, and can negatively impact the responsiveness of games. This latency is particularly noticeable in fast-paced games where timely user inputs are crucial for an immersive experience. The resulting input lag can frustrate players and degrade the overall quality of the gaming experience.

In addition, the heterogeneity of client devices poses additional challenges. Cloud gaming services must cater to a diverse array of hardware capabilities, from high-end gaming PCs to entry-level mobile devices. Ensuring a consistent and high-quality gaming experience across this spectrum of devices requires scalable solutions that can adapt to varying processing power and display resolutions.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates various graphics rendering pipelines.

FIG. 2 illustrates a rendering pipeline designed to optimize cloud gaming performance by performing upscaling and interpolation operations at a client device.

FIG. 3 illustrates a rendering pipeline incorporating a machine learning model executed by one or more neural networks to perform upscaling and interpolation / extrapolation operations at a client device, in accordance with some embodiments.

FIG. 4 illustrates a rendering pipeline incorporating machine learning techniques by one or more neural networks executing on a server and on a communicatively coupled client device, in accordance with some embodiments.

FIG. 5 is a block diagram of a processing system designed to implement a neural network-based rendering pipeline in accordance with one or more embodiments.

FIG. 6 illustrates an operational flow diagram for a neural network-based rendering pipeline, in accordance with some embodiments.

### DETAILED DESCRIPTION

Existing cloud gaming approaches often attempt to balance the competing demands of visual fidelity, latency, and frame rate in various ways. Some approaches utilize aggressive data compression and lower resolution streaming to mitigate bandwidth limitations, but this can lead to visual artifacts and a less immersive experience. Other approaches include predictive rendering techniques that anticipate user inputs to reduce perceived latency, but can be computationally intensive and may not always accurately reflect the player's intentions.

In light of these challenges, there is a need to effectively address tradeoffs between graphical quality, latency, and frame rate in cloud gaming. Embodiments of techniques described herein do so by utilizing one or more trained neural networks as individual processing stages of a graphics rendering pipeline having multiple such processing stages. In certain embodiments, latency is further mitigated by providing local user input (user input received at a local client device) and/or one or more predicted user inputs (potential future user input that is predicted based on local user input) to the trained neural networks performing various transformation operations during those processing stages. In various scenarios, such embodiments operate to optimize data transmission, enhance visual fidelity, and minimize latency to deliver a seamless and immersive gaming experience, regardless of the user's client device or network connection quality.

As used herein, a frame refers to a single image or snapshot in a sequence of images that make up a video or animation. In the context of rendering and gaming, a frame represents the visual output generated for a specific point in time, capturing the state of the scene, including all visual elements such as objects, lighting, and shadows. Frames are rendered in quick succession to create the illusion of motion, and each frame is processed to ensure smooth transitions and high visual fidelity in the final display. A graphics rendering pipeline refers to a series of steps and processes performed by one or more circuitry modules that are configured to operate in processing stages to convert 3D models, textures, and other scene data into 2D frames suitable for visual presentation. This rendering pipeline typically includes stages such as geometry processing, lighting calculations, shading, texturing, and post-processing effects. The rendering pipeline transforms the high-level description of a scene into the final visual output by applying various algorithms and techniques to simulate realistic lighting, shadows, reflections, and other visual effects.

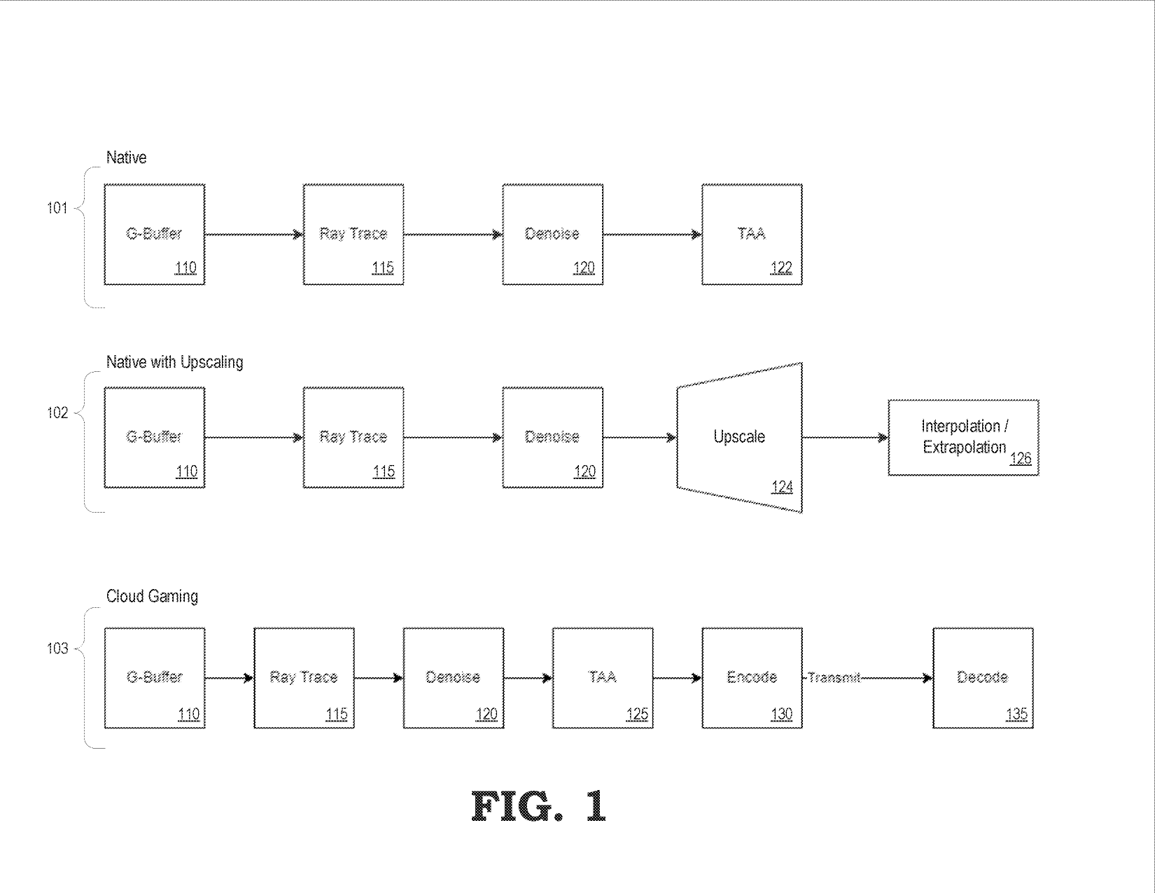

FIG. 1 illustrates various graphics rendering pipelines (also simply referred to herein as rendering pipelines), including a native rendering pipeline 101, native rendering with upscaling pipeline 102, and cloud gaming rendering pipeline 103. Each pipeline is designed to optimize the visual quality and performance of gaming applications while addressing the challenges of computational load and data transmission.

The native rendering pipeline 101 begins with a geometry buffer (G-buffer) 110, which stores geometric information about the scene. The G-buffer 110 is followed by ray trace processing stage 115, which performs ray tracing operations to generate high-fidelity lighting and shadow effects by simulating the interaction of light with objects in the scene. The output from the ray trace processing stage 115 is then processed by a denoising processing stage 120, which reduces noise artifacts introduced during the ray tracing process. Subsequently, a temporal anti-aliasing (TAA) processing stage 122 applies anti-aliasing techniques to smooth out jagged edges in the rendered frame, resulting in a final frame ready for display.

The upscaling pipeline 102 modifies the operations of native rendering pipeline 101 by introducing an upscaling process to enhance the visual quality further. In a manner similar to that described above with respect to native rendering pipeline 101, the pipeline 102 begins with a G-buffer 110, followed by the ray trace processing stage 115 and the denoising processing stage 120. However, instead of proceeding directly to a TAA processing stage, the output from the denoising processing stage 120 is instead passed to an upscaling processing stage 124. The upscaling processing stage 124 employs upscaling techniques to increase the resolution of the frame, thereby enhancing its visual fidelity. Following the upscaling process, the output frame sequence may be transformed by interpolation / extrapolation processing stage 126, which generates one or more additional frames based on the upscaled frame to insert into the rendered output stream, such as to provide smoother motion and reduce latency. As used herein, frame interpolation involves generating intermediate frames between two known frames, using information from the surrounding frames to generate new frames for a frame sequence; frame extrapolation involves generating one or more future frames based on patterns in motion detected in previous frames of a sequence.

A third pipeline, identified as cloud gaming pipeline 103, depicts a rendering pipeline optimized for cloud-based gaming (gameplay in which a gaming application executes on a server that is remote from the user/player, such that rendered frames are provided from the server to the user via one or more intervening networks), in contrast with rendering pipelines 101, 102 that typically operate entirely locally with respect to an executing gaming application. As with the previous pipelines, the process begins with the G-buffer 110, ray trace processing stage 115, and denoising processing stage 120. The output is then processed by the TAA processing stage 125 to smooth out jagged edges. Following the TAA processing stage 125, an encoding processing stage 130 compresses the frame data for efficient transmission over the one or more intervening networks. The encoded data is then transmitted to the client device, where it is decoded by decoding processing stage 135. The decoded frame is ready for display on the client device.

These rendering pipelines illustrate previous approaches used to achieve high-quality, low-latency gaming experiences across various platforms. The use of upscaling and interpolation/extrapolation in the pipeline 102 improves visual fidelity and performance on local devices, while the cloud gaming pipeline 103 addresses the challenges of data transmission and processing in remote gaming scenarios.

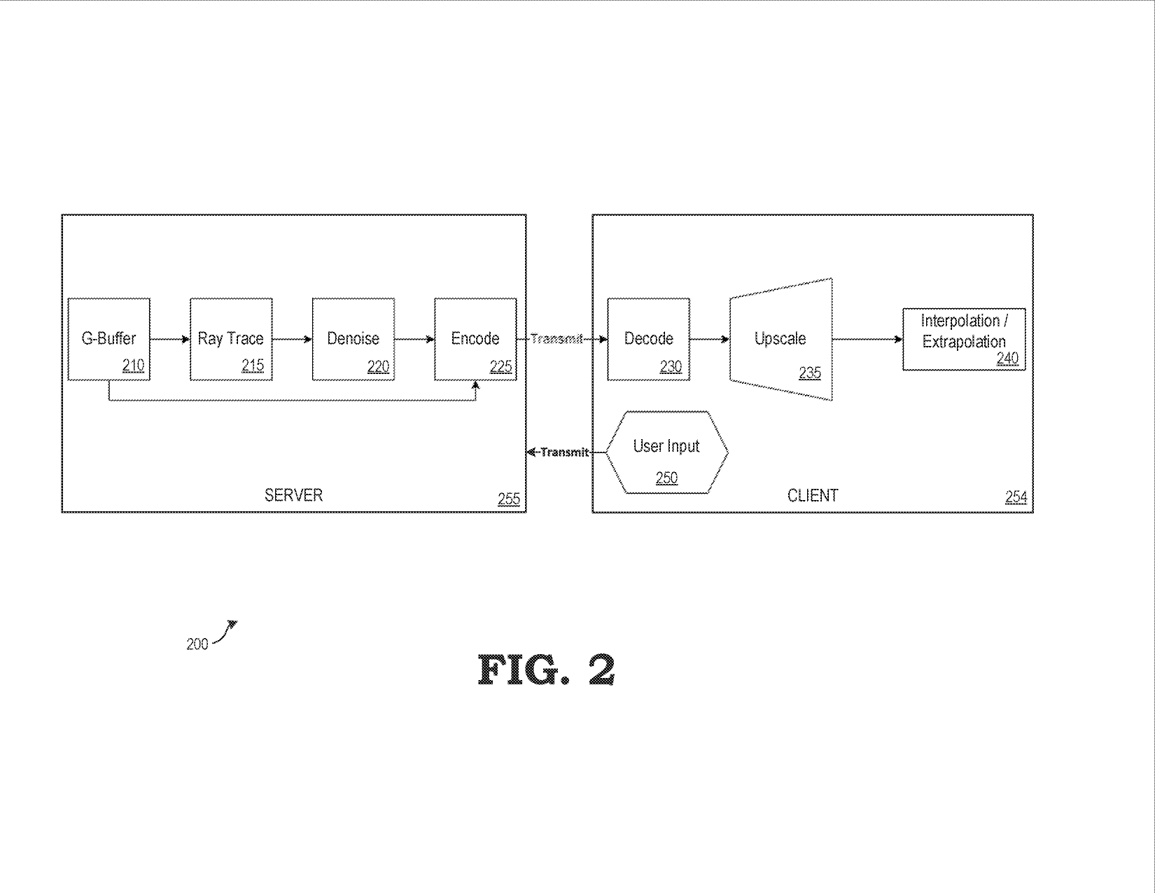

FIG. 2 illustrates a rendering pipeline 200 designed to optimize cloud gaming performance by performing upscaling and interpolation operations at a client device 254. The rendering pipeline 200 enhances visual fidelity and reduces bandwidth requirements while addressing latency issues through user input integration.

The rendering pipeline 200 begins at a server 255 with a G-buffer 210, which stores geometric information about the scene. The G-buffer 210 is followed by a ray trace processing stage 215, which performs ray tracing operations to generate high-fidelity lighting and shadow effects by simulating the interaction of light with objects in the scene. The output from the ray trace processing stage 215 is then processed by a denoising processing stage 220, which reduces noise artifacts introduced during the ray tracing process.

Next, the processed data is handled by an encoding processing stage 225, which compresses the frame data for efficient transmission over the network. This compression step reduces the bandwidth required to transmit high-quality graphics data. The encoded data is then transmitted to the client device 254.

Upon receiving the transmitted data, a decoding processing stage 230 on the client device 254 decompresses the frame data. Following the decoding process, the data is passed to an upscaling processing stage 235. The upscaling processing stage 235 generates a higher-resolution version of the decoded frame, thereby enhancing its visual fidelity. The upscaled frame then undergoes processing by an interpolation/extrapolation processing stage 240, which generates one or more additional frames based on the upscaled frame. This step is designed to insert extra frames into the rendered stream, providing smoother motion and reducing latency.

In the depicted embodiment, user input 250 is received and transmitted back to the server 255, enabling real-time interaction and adjustments to the rendered scene based on that user input 250. This integration of user input 250 allows the server 255 to dynamically respond to the player's input actions.

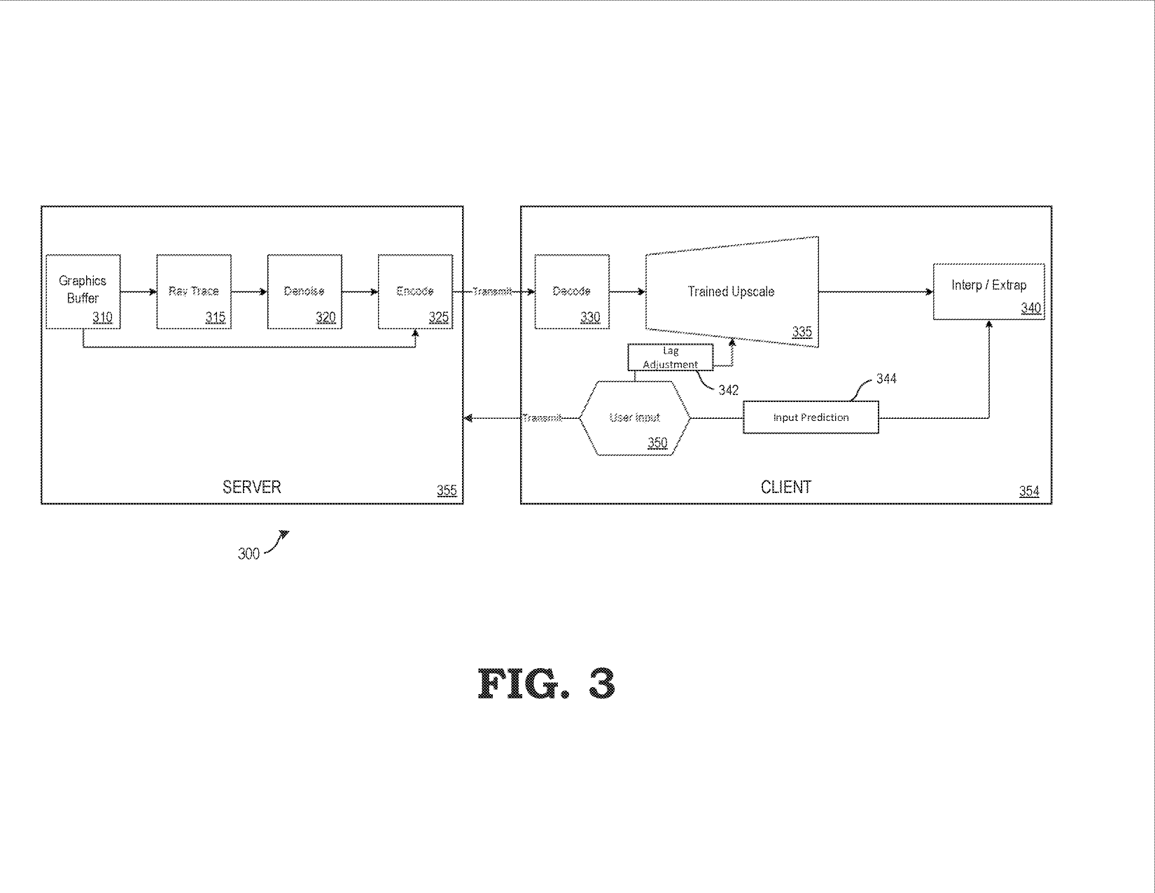

FIG. 3 illustrates a rendering pipeline 300 designed to optimize cloud gaming performance by incorporating a machine learning model, executed by one or more neural networks, to perform upscaling and interpolation/extrapolation operations at a client device 354, with additional features for lag adjustment based on local user input (user input captured at the client device 354), in accordance with some embodiments. The depicted embodiment enhances visual fidelity, reduces bandwidth requirements, and addresses latency issues through dynamic user input integration.

The rendering pipeline 300 begins at a server 355 with a graphics buffer 310, which receives scene data representing at least a portion of a frame to be rendered for display and stores geometric and other information about the scene. In various embodiments, the graphics buffer 310 may comprise one or more G-buffers and/or one or more auxiliary data buffers to store scene data representing at least a portion of a frame to be rendered for display. The graphics buffer 310 is followed by a ray trace processing stage 315, which performs ray tracing operations to generate high-fidelity lighting and shadow effects by simulating the interaction of light with objects in the scene. The output from the ray trace processing stage 315 is then processed by a denoise processing stage 320, which reduces noise artifacts introduced during the ray tracing process. Next, the processed data is handled by an encoding processing stage 325, which compresses the frame data for efficient transmission over one or more networks. In this manner, the operations and functionality provided by the graphics buffer 310, ray trace processing stage 315, denoising processing stage 320, and encoding processing stage 325 are substantially identical to the analogous components of the rendering pipeline 200 discussed above with respect to FIG. 2. In general, each of the multiple processing stages of the rendering pipeline 300 generates intermediate data based on the received scene data and on input data passed to that processing stage from the previous processing stage.

Upon receiving the transmitted data, a decoding processing stage 330 on the client device 354 decompresses the frame data. Following the decoding process, the data is passed to a trained upscaling processing stage 335. In certain embodiments, the trained upscaling processing stage 335 performs one or more operations via a neural network that is trained to work with lossy compression and to convert the frame from a low to high bit rate, thereby enhancing its visual fidelity. In some embodiments, operations performed by the trained upscaling processing stage 334 further include color conversion operations, such as to convert standard dynamic range (SDR) input frames to high dynamic range (HDR) or other conversions.

As used herein, training refers to a process by which a machine learning model implemented by a neural network is taught to perform specific tasks by being provided with one or more training datasets, and to responsively adjust its parameters to minimize errors. In certain embodiments, such training involves iterative optimization techniques (e.g., using residual vectors to process differences between predicted dataset values and actual dataset values) that improve the model's accuracy and efficiency in tasks such as denoising, encoding, decoding, and/or upscaling. Once trained, the machine learning model can apply its learned capabilities to new data, effectively performing the desired operations based on the patterns and relationships it has learned during training.

For example, in certain embodiments the training of upscaling processing stage 335 involves using one or more input datasets that comprises pairs of a low-resolution version and high-resolution version of multiple frames, potentially with additional associated information such as geometry and color information. In certain embodiments and scenarios, such pairs include a high-quality frame and a corresponding compressed version of the frame, which enables a model-implementing neural network to learn to identify and reduce compression artifacts. In certain embodiments and scenarios, training datasets include data about scene geometry, such as depth information, normals, motion vectors, and other attributes. Generally, the neural network is trained using a training dataset comprising pairs of original frames and corresponding frames that have been transformed in a manner corresponding to the one or more transformations that the neural network is to perform within the rendering pipeline 300. Such information enables the neural network to develop an understanding of the scene's structure and to improve its accuracy when performing those transformations on input data provided from a previous one of the multiple processing stages of the rendering pipeline 300.

In certain embodiments and scenarios, training datasets include color and texture information associated with one or more frames, such as to enable the relevant neural network to preserve color fidelity and texture details during encoding and/or compression. For training processing stages that handle video data, temporal datasets comprising consecutive frames may be used to help the relevant neural network maintain temporal consistency and reduce temporal artifacts in a compressed series of frames. In certain embodiments, residual vectors are used to represent differences between the original high-quality frames and the predicted frames, and are used to train the neural network.

Continuing with the rendering pipeline 300, following the operations performed by a trained upscaling processing stage 335 the upscaled frame undergoes processing by an interpolation/extrapolation processing stage 340, which generates one or more intermediate frames based on the upscaled frame. The interpolation/extrapolation processing stage 340 inserts these intermediate frames into the rendered output stream, such as to provide smoother motion and reduce latency. In certain embodiments, interpolation/extrapolation processing stage 340 utilize a trained machine learning model to predict one or more aspects of such intermediate frames, such as to further enhance the smoothness of motion and reduce latency in the rendered stream. As one example, in certain embodiments and scenarios the trained interpolation/extrapolation processing stage 440 is trained on one or more datasets comprising sequences of frames, such as in order to learn temporal dynamics associated with the generation of accurate intermediate frames.

In the depicted embodiment, user input 350 is received at the client device 354 and transmitted back to the server 355, enabling real-time interaction and adjustments to the rendered scene. The rendering pipeline 300 incorporates a lag adjustment processing stage 342, which dynamically adjusts the rendering process based on user input 350 to minimize perceived latency. In certain embodiments, the lag adjustment processing stage 342 reprojects one or more frames based on the user's inputs, adjusting a position or orientation of the rendered scene to account for changes in the viewer's perspective and/or to correct for latency. In this manner, the rendering pipeline 300 ensures that its rendered output stream appears more responsive.

Also in the depicted embodiment, a prediction processing stage 344 utilizes the user input to predict future actions, further refining the rendering process and ensuring a responsive gaming experience. In certain embodiments, the prediction processing stage 344 leverages machine learning algorithms to forecast the user's next movements, enabling the rendering pipeline to preemptively adjust and render frames that align with these predictions. In certain embodiments and scenarios, such a combined approach significantly reduces user-perceived lag and enhances the overall gaming experience by maintaining both highly responsive interactivity and visual fidelity.

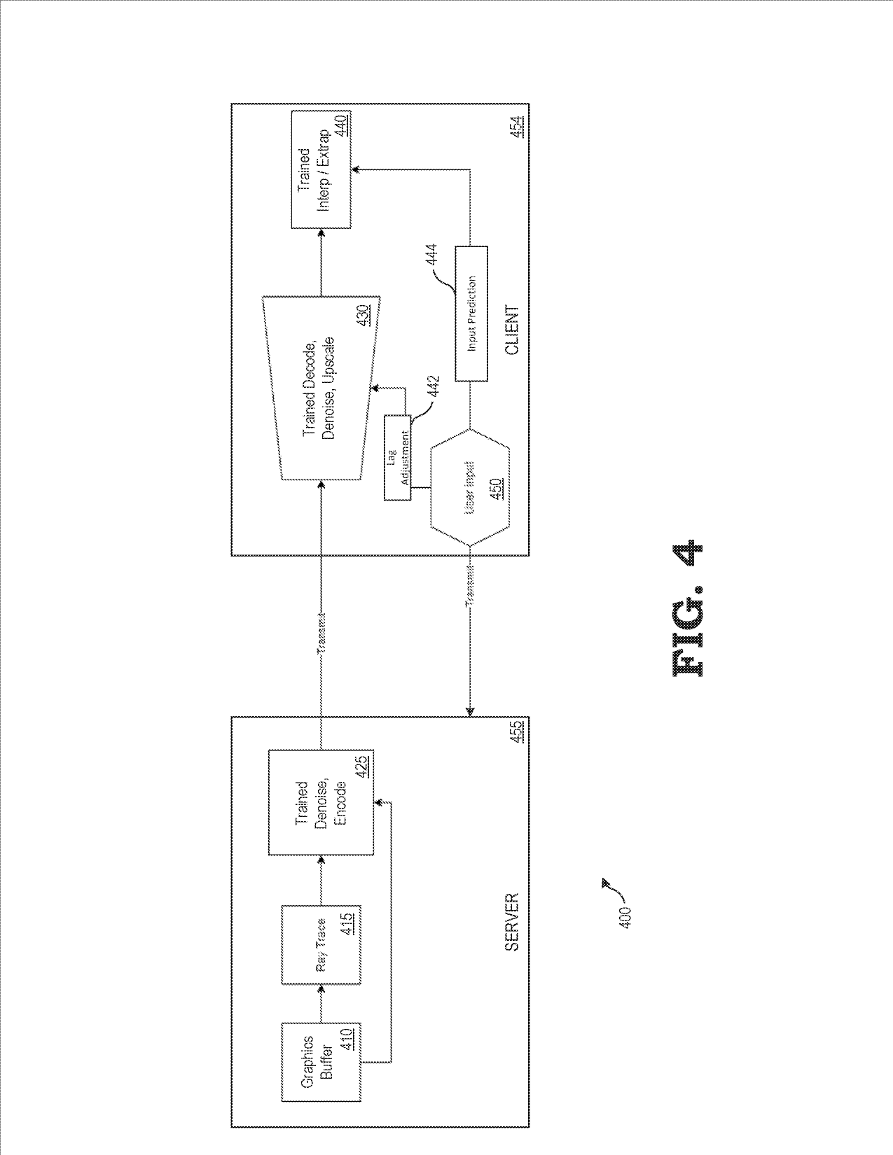

FIG. 4 illustrates a rendering pipeline 400 designed to optimize cloud gaming performance via machine learning techniques for frame operations, by one or more neural networks executing on a server and on a communicatively coupled client device, that include denoising, encoding, decoding, upscaling, and interpolation/extrapolation operations, in accordance with some embodiments. In the depicted embodiment, one or more trained neural networks are also leveraged to integrate user input for dynamic rendering adjustments, thereby improving visual fidelity and reducing latency.

The rendering pipeline 400 begins at a server 455 with a graphics buffer 410 and then a ray trace processing stage 415, both of which operate substantially identically to the graphics buffer 310 and ray tracing processing stage 315 discussed above with respect to rendering pipeline 300 of FIG. 3. The output from the ray tracing processing stage 415 is then processed by a trained denoising and encoding processing stage 425. In general, each of the multiple processing stages of the rendering pipeline 400 generates intermediate data based on the received scene data and on input data passed to that processing stage from the previous processing stage.

The trained denoising and encoding processing stage 425 utilizes one or more neural networks to compress redundant scene information such as color and geometry, efficiently compressing data while preserving essential details. This processing stage is designed to handle the high-fidelity lighting and shadow effects generated by the ray trace processing stage 415, reducing noise artifacts such as those produced by the ray tracing process. The trained denoising and encoding processing stage 425 then compresses the data to optimize it for transmission. In the depicted embodiment, the trained denoising and encoding processing stage 425 receives input from both the preceding ray trace processing stage 415 and directly from the graphics buffer 410. In certain embodiments, the implementing one or more neural networks are trained using datasets comprising high-quality and compressed frame pairs in order to optimize the performed compression techniques, with such training datasets teaching the one or more neural networks to identify and reduce redundant information while maintaining the visual integrity of the frames.

Upon receiving the transmitted data, a trained decoding/denoising/upscaling processing stage 430 on the client device 454 processes the input data received from trained denoising and encoding processing stage 425. The trained decoding/denoising/upscaling processing stage 430 is trained to work effectively with lossy compression, minimizing any artifacts introduced during compression. Upon decoding the transmitted data, the processing stage applies trained denoising techniques to further optimize visual clarity of the frames. In certain embodiments, the trained decoding/denoising/upscaling processing stage 430 additionally converts the frames from a lower bit rate to a higher bit rate.

The upscaled frame then undergoes processing by a trained interpolation & extrapolation processing stage 440, which comprises a neural network that is trained to generate one or more additional frames of a frame sequence, and which generates one or more additional intermediate frames based on the upscaled frame provided from the trained decoding/denoising/upscaling processing stage 430. The interpolation & extrapolation processing stage 440 inserts these intermediate frames into the rendered output stream from the rendering pipeline 400, providing a user perception of smoother motion and reduced latency.

User input 450 is provided at the client device 454 and transmitted back to the server 455, enabling real-time interaction and adjustments to the rendered scene. In the depicted embodiment, the rendering pipeline 400 incorporates a lag adjustment processing stage 442, which provides local user input at the client device (and therefore not subject to the latency introduced by network transmission and server processing) to the trained decoding/denoising/upscaling processing stage 430. The decoding/denoising/upscaling processing stage 430 dynamically adjusts the rendering process (and in particular the transformation operations performed by trained decoding/denoising/upscaling processing stage 430) based on the local user input 450 to minimize perceived latency. In some embodiments, the lag adjustment processing stage 442 reprojects the frame to be rendered based on the user input 450, such as to adjust the rendered scene to account for changes in the viewer's perspective caused by that user input.

Also in the depicted embodiment, a prediction processing stage 444 utilizes the user input 450 to predict future one or more future user inputs, further refining the rendering process and ensuring a responsive gaming experience. The prediction processing stage 444 leverages machine learning to forecast the user's next movements, allowing the rendering pipeline to preemptively adjust and render frames that align with that predicted future input. In certain embodiments and scenarios, the lag adjustment processing stage 442 and the prediction processing stage 444 may significantly reduce perceived latency, individually and/or in combination.

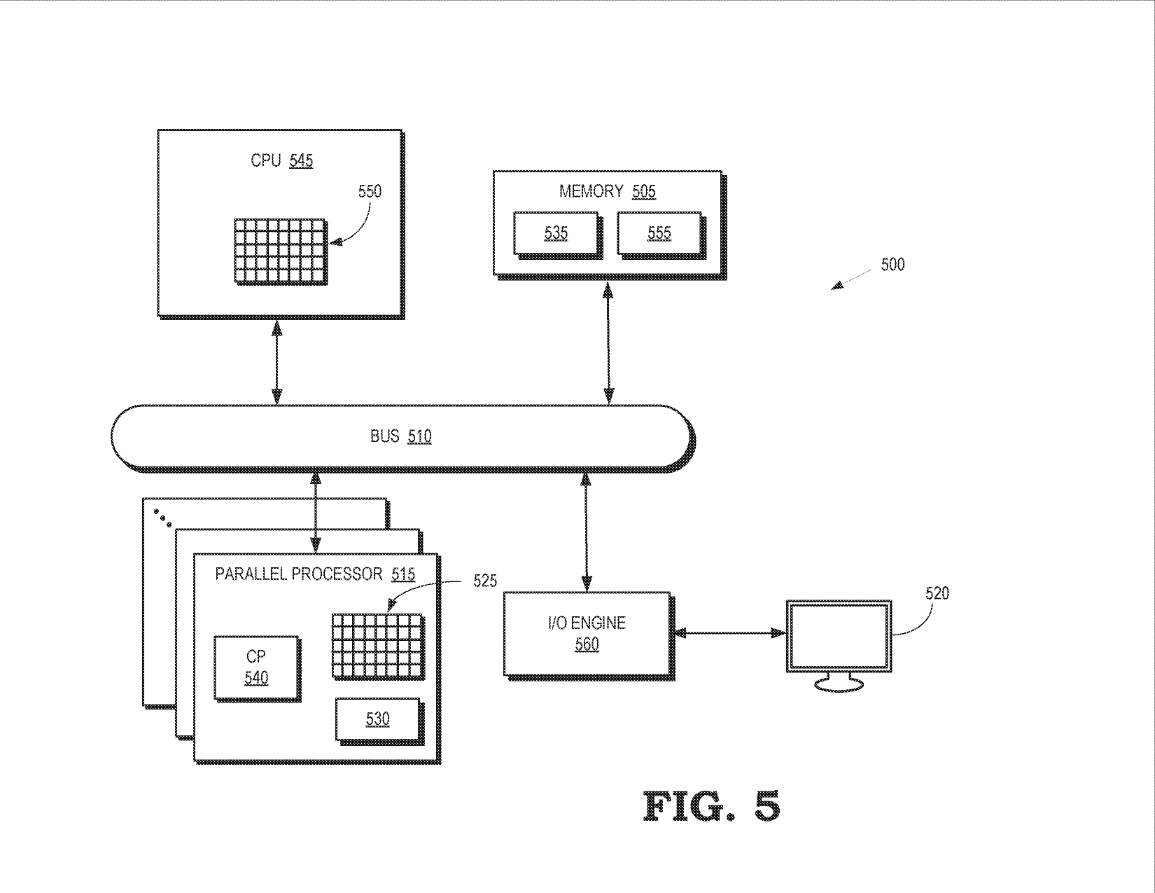

FIG. 5 is a block diagram of a processing system 500 designed to implement a neural network-based rendering pipeline (e.g., the rendering pipeline 300 of FIG. 3 and/or rendering pipeline 400 of FIG. 4) in accordance with one or more embodiments. The processing system 500 is generally designed to execute sets of instructions or commands to carry out tasks on behalf of an electronic device, such as a desktop computer, laptop computer, server, smartphone, tablet, game console, and the like.

The processing system 500 includes or has access to a memory 505 or other storage component that is implemented using a non-transitory computer-readable medium, such as dynamic random access memory (DRAM). In the depicted embodiment, memory 505 stores rendering data and intermediate computation results in block 535. In various scenarios, such rendering data and intermediate computation results may include frame buffers, which hold pixel data for frames being processed; configuration data, which contains parameters and settings for rendering tasks; and other data structures used by the parallel processor 515 and the CPU 545 during the rendering process. The memory 505 also includes program code 555, which contains the instructions executed by the CPU 545 and parallel processor 515. The processing system 500 also includes a bus 510 to support communication between entities implemented in the processing system 500, such as the memory 505. In certain embodiments, the processing system 500 includes other buses, bridges, switches, routers, and the like, which are not shown in FIG. 5 in the interest of clarity.

The processing system 500 includes one or more parallel processors 515 that are configured to render frames for presentation on a display 520. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 515 can render objects to produce pixel values that are provided to the display 520. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 515 is also used for general-purpose computing. For instance, the parallel processor 515 can be used to implement machine learning algorithms such as one or more implementations of a neural network as described herein. In some cases, operations of multiple parallel processors 515 are coordinated to execute a machine learning algorithm, such as if a single parallel processor 515 does not possess enough processing power to run the machine learning algorithm on its own.

The parallel processor 515 implements multiple processing elements (also referred to as compute units) 525 that are configured to execute instructions concurrently or in parallel. The parallel processor 515 also includes an internal (or on-chip) memory 530 that includes a local data store (LDS), as well as caches, registers, or buffers utilized by the compute units 525. The parallel processor 515 can execute instructions stored in the memory 505 and store information in the memory 505 such as the results of the executed instructions. The parallel processor 515 also includes a command processor 540 that receives task requests and dispatches tasks to one or more of the compute units 525.

The processing system 500 also includes a central processing unit (CPU) 545 that is connected to the bus 510 and communicates with the parallel processor 515 and the memory 505 via the bus 510. The CPU 545 implements multiple processing elements (also referred to as processor cores) 550 that are configured to execute instructions concurrently or in parallel. The CPU 545 can execute instructions such as program code 555 stored in the memory 505 and the CPU 545 can store information in the memory 505 such as the results of the executed instructions.

An input/output (I/O) engine 560 handles input or output operations associated with the display 520, as well as other elements of the processing system 500 such as keyboards, mice, printers, external disks, and the like. The I/O engine 560 is coupled to the bus 510 so that the I/O engine 560 communicates with the memory 505, the parallel processor 515, or the CPU 545.

In operation, the CPU 545 issues commands to the parallel processor 515 to initiate processing of a kernel that represents the program instructions that are executed by the parallel processor 515. Multiple instances of the kernel, referred to herein as threads or work items, are executed concurrently or in parallel using subsets of the compute units 525. In some embodiments, the threads execute according to single-instruction-multiple-data (SIMD) protocols so that each thread executes the same instruction on different data. The threads are collected into workgroups (also termed thread groups) that are executed on different compute units 525. For example, the command processor 540 can receive these commands and schedule tasks for execution on the compute units 525.

In some embodiments, the parallel processor 515 implements a graphics rendering pipeline that includes multiple stages configured for concurrent processing of different primitives in response to a draw call. Stages of the graphics rendering pipeline in the parallel processor 515 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware- or software-implemented construct in a processing system, such as processing system 500. In various embodiments, such a layer may perform one or more operations via processing circuitry of the processing system 500 to serve as a collection or group of interconnected neurons or nodes, arranged in a structure that can be optimized for execution on one or more parallel processors (e.g., parallel processors 515) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data — for example, raw data input into an input layer or the transformed data passed between hidden layers. This transformation process involves the use of an output weight matrix, which is held in memory (e.g., memory 505) and manipulated by the central processing unit (CPU) 545 and/or the parallel processors 515.

In some instances, such layers may be distributed across multiple processing units within a system. For instance, different layers or groups of layers may be executed on different compute units 525 within a single parallel processor 515, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

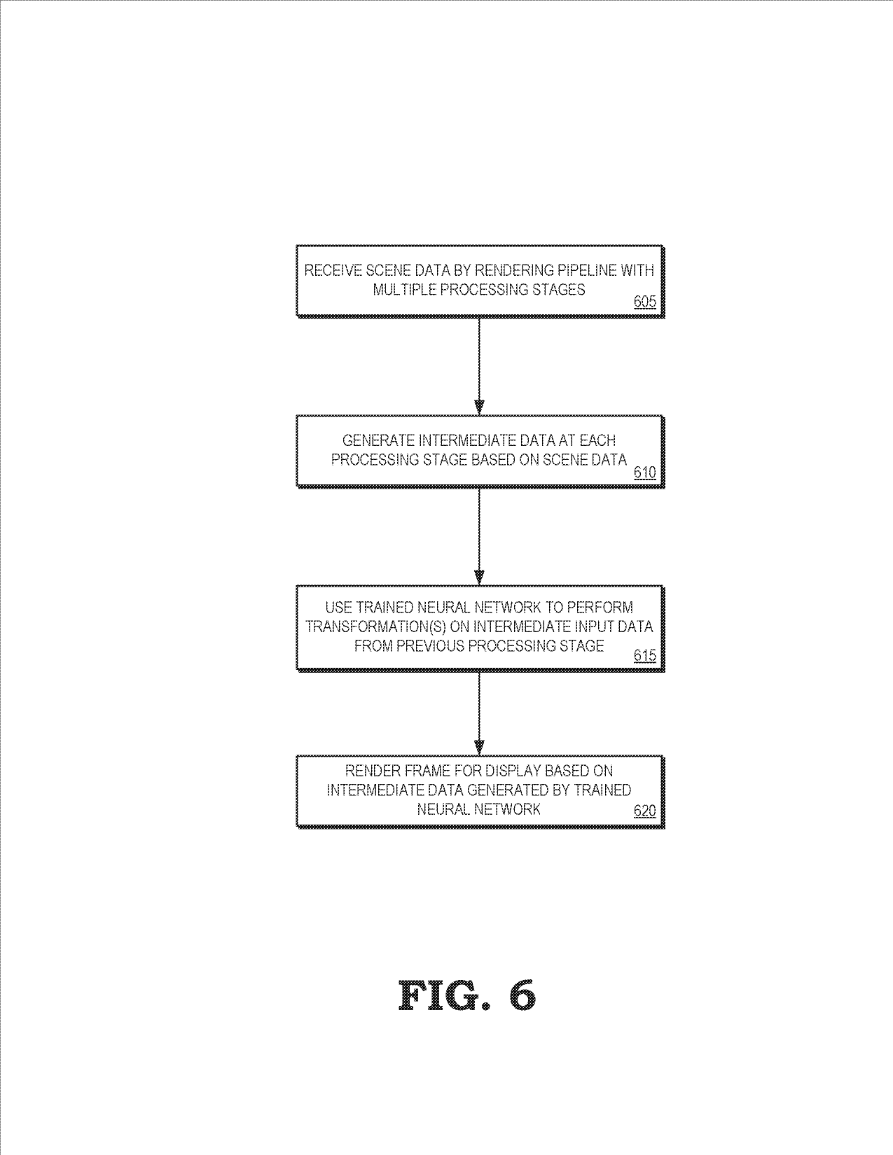

FIG. 6 illustrates a flow diagram of an operational routine 600 for a neural network-based rendering pipeline (e.g., rendering pipeline 300 of FIG. 3 and/or rendering pipeline 400 of FIG. 4) to render a frame for processing and display, in accordance with some embodiments. The operational routine 600 may be performed, for example, by a processing system (e.g., processing system 500 of FIG. 5) executing an embodiment of one or more neural networks as one or more processing stages of the rendering pipeline.

The operational routine 600 begins at block 605, where scene data representing at least a portion of a frame to be rendered for display is received by the rendering pipeline, which comprises multiple processing stages. In various embodiments, this scene data includes geometric information, color and texture data, and other relevant attributes necessary for rendering the frame.

At block 610, intermediate data is generated at each processing stage based on the received scene data. Each processing stage processes the input data from the previous stage, transforming it as needed to prepare it for the next stage in the pipeline. This intermediate data serves as the foundation for the final rendered frame.

At block 615, at least one processing stage of the multiple processing stages uses a trained neural network to perform one or more transformations on the intermediate input data received from the previous processing stage. These transformations may include denoising, encoding, decoding, upscaling, and other operations as described in the context of the trained processing stages in FIGS. 3 and 4. The trained neural network is designed to enhance the quality of the data and optimize it for rendering.

At block 620, the frame is rendered for display (such as via display device 520 of FIG. 5) based at least in part on the intermediate data generated by the trained neural network.

This operational routine 600 demonstrates the method of using a neural network-based rendering pipeline to efficiently process and render frames for display, leveraging machine learning techniques and one or more neural networks to enhance the quality and performance of the rendering process.

In some embodiments, the apparatus and techniques described above are implemented in a system including one or more integrated circuit (IC) devices (also referred to as integrated circuit packages or microchips), such as the neural network-based rendering pipelines described above with reference to FIGS. 3-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, by a graphics rendering pipeline having multiple processing stages, scene data representing at least a portion of a frame to be rendered for display;
generating, by each of one or more of the multiple processing stages, intermediate data based on the received scene data, wherein for at least one processing stage of the multiple processing stages, generating the intermediate data comprises performing one or more transformations on input data from a previous one of the multiple processing stages by a trained neural network; and
rendering the frame for display based at least in part on the intermediate data generated by the trained neural network.

2. The method of claim 1, wherein performing the one or more transformations comprises performing one or more of a group that includes denoising operations, encoding operations, decoding operations, and upscaling operations.

3. The method of claim 2, further comprising training the neural network based on a training dataset comprising pairs of original frames and corresponding frames that have been transformed in a manner corresponding to the one or more transformations.

4. The method of claim 1, wherein the multiple processing stages comprise a neural network trained to generate one or more additional frames of a frame sequence.

5. The method of claim 1, wherein a first portion of the multiple processing stages is performed at a server, wherein a second portion of the multiple processing stages is performed at a client device located remotely from the server, and wherein the first portion of the multiple processing stages comprises encoding frame data for transmission from the server to the client device.

6. The method of claim 5, wherein the first portion of the multiple processing stages comprises a neural network that is trained to perform one or more of a group that comprises denoising operations and encoding operations.

7. The method of claim 5, wherein the second portion of the multiple processing stages comprises one or more neural networks, the one or more neural networks being trained to perform one or more of a group that comprises decoding operations, denoising operations, upscaling operations, frame interpolation, and frame extrapolation.

8. The method of claim 6, further comprising providing local user input at the client device to the one or more trained neural networks of the second portion of the multiple processing stages.

9. The method of claim 1, wherein the multiple processing stages comprise a neural network trained to generate one or more additional frames of a frame sequence, and wherein the method further comprises providing to the trained neural network one or more predicted user inputs for use in generating the one or more additional frames.

10. A system, comprising:
a first portion of a graphics rendering pipeline having multiple processing stages, the first portion to receive scene data representing at least a portion of a frame to be rendered for display; and
a second portion of the graphics rendering pipeline, the second portion to generate one or more output frames for display based at least in part on the received scene data;
wherein at least one processing stage of the multiple processing stages comprises a neural network trained to perform one or more transformations on input data from a previous processing stage of the multiple processing stages.

11. The system of claim 10, wherein the one or more transformations comprises one or more of a group that includes denoising operations, encoding operations, decoding operations, and upscaling operations.

12. The system of claim 11, wherein the neural network is trained based on a training dataset comprising pairs of original frames and corresponding frames that have been transformed in a manner corresponding to the one or more transformations.

13. The system of claim 10, wherein the multiple processing stages comprise a neural network trained to generate one or more intermediate frames for a frame sequence comprising the one or more output frames.

14. The system of claim 10, wherein the first portion of the graphics rendering pipeline comprises one or more processing stages at a server, wherein the second portion of the graphics rendering pipeline comprises one or more processing stages at a client device located remotely from the server, and wherein the first portion of the graphics rendering pipeline encodes frame data for transmission from the server to the client device.

15. The system of claim 14, wherein the first portion of the graphics rendering pipeline comprises a neural network that is trained to perform one or more of a group that comprises denoising operations and encoding operations.

16. The system of claim 14, wherein the second portion of the graphics rendering pipeline comprises one or more neural networks trained to perform one or more of a group that comprises decoding operations, denoising operations, upscaling operations, frame interpolation, and frame extrapolation.

17. The system of claim 16, further comprising a lag adjustment processing stage to provide local user input at the client device to the one or more trained neural networks of the second portion of the graphics rendering pipeline.

18. The system of claim 10, wherein the second portion of the graphics rendering pipeline comprises an interpolation neural network trained to generate one or more additional frames of a frame sequence, and wherein the one or more transformations include one or more of a group that comprises frame interpolation operations and frame extrapolation operations.

19. The system of claim 18, further comprising an input prediction processing stage to provide one or more predicted user inputs to the interpolation neural network for use in generating the one or more additional frames.

20. A non-transitory computer-readable medium storing a set of executable instructions that, when executed by one or more processors, manipulate the one or more processors to:
receive, by a graphics rendering pipeline having multiple processing stages, scene data representing at least a portion of a frame to be rendered for display;
generate, by each of one or more of the multiple processing stages, intermediate data based on the received scene data, wherein at least one processing stage of the multiple processing stages generates the intermediate data by performing, by a trained neural network, one or more transformations on input data from a previous processing stage of the multiple processing stages; and
render the frame for display based at least in part on the intermediate data generated by the trained neural network.
